(19) United States
(12) Patent Application Publication
(10) Pub. No.: US 2012/0277047 A1
(43) Pub. Date: Nov. 1, 2012

(54) TOOTHED CABLE

(75) Inventors: Masato INOUE, Takarazuka-shi (JP); Daichi Shimizu, Takarazuka-shi (JP)

(73) Assignee: HI-LEX CORPORATION, Takarazuka-shi (JP)

(21) Appl. No.: 13/456,655

(22) Filed: Apr. 26, 2012

(30) Foreign Application Priority Data
Apr. 28, 2011 (JP) 2011-101281

(51) Int. Cl. F16G 1/18

(52) U.S. Cl. 474/239

(57) ABSTRACT

The present invention has an object of providing a toothed cable 1 not to cause an unnecessary load on a motor or the like, not to cause tear in the cover layer and to have excellent durability. The present invention provides a toothed cable 1 comprising a core cable 2, and a tooth line 3 helically wound on the outer periphery of the core cable 2. The toothed cable 1 further comprises a cover layer 4 covering the outer surface of the core cable 2 and the tooth line 3 with a resin continuously. This toothed cable 1 has helical convex portions 41 formed by covering the tooth line 3 with the resin and helical concave portions 42 formed by covering intervals in the tooth line with the resin, and the covered layer 4 is in contact with the core cable 2 and the tooth line 3.

### TECHNICAL FIELD

The present invention relates to a toothed cable with excellent durability.

### BACKGROUND OF THE INVENTION

Conventionally, a toothed cable for transmitting a driving force in the direction of axis line by means of tooth line which is helically wound on the outer periphery of a core cable comprising metal wires is known as a mechanism for transmitting a driving force, for example, from a gear. In the toothed cable, concave portions and convex portions are formed by tooth line alternatively and repeatedly along the direction of the axis line of the toothed cable. The teeth of the gear engages the concave portions so that the toothed cable is driven along the direction of the axis line thereof and a driving force is transmitted from a driving source such as a gear. An example of such a toothed cable is disclosed in JP-A-56-405109 In JP-A-56-105109, as shown in FIG. 4, a toothed cable 100 comprises a cover layer 101 extending on both a helically wound coil 102 and a cable core 103, and a thickness of the cover layer 101 is relatively thick on the crest 102a of a winding portion of the helically wound coil 102 while a thickness of the cover layer 101 is relatively thin on the surface 103a of the cable core between the winding portions.

In addition, in WO 2005/116463, as shown in FIG. 5, another toothed cable 110 comprising a core cable 113 composed of a plurality of metal wires, tooth line 112, i.e. a metal wire helically wound onto the outer periphery of the core cable 113 at even intervals, and a tube-like resin coat 111 with concavities and convexities which is provided on the outer periphery of the toothed cable 110 by extrusion molding is disclosed. In the toothed cable 110, a clearance space is formed between the concave portion of the tube-like resin coat 111 and the surface of the core cable 113 and the convex portion of the tube-like resin coat 111 contacts the tooth line 112.

### SUMMARY OF THE INVENTION

In JP-A-56-105109, the toothed cable 100 in which the cover is layer 101 extends on both the helically wound coil 102 and the cable core 103, and the thickness of the cover layer 101 is thick on the crest 102a of a winding portion of the helically wound coil 102 while being thin on the surface 103a of the cable core between the winding portions prevents noise and has durability against abrasion. However, in the toothed cable of JP-A-56-105109, since the difference in height between the concave and convex on the toothed cable 100 is relatively large, each tooth of a gear (not shown) to be engaged with the toothed cable 100 is caught on the crest 102a of the winding portion, i.e. on the convex portion of the toothed cable 100 and this results in an unnecessary load on a motor (not shown) which drives the toothed cable 100 or a gear.

Moreover, a toothed cable provided with helical tooth line on the outer periphery of a core is more likely to generate noise when engaged with a gear such as a pinion or a rack. In order to prevent the noise, as shown in WO 2005/116463, the toothed cable 110 covered with the tube-like resin coat 111 and having a clearance space between the resin coat 111 and the core cable 113 is proposed. However, due to the space S between the resin coat 111 and the core cable 113, the toothed cable must be engaged with a gear on condition that there is no tear generated in the resin coat 111.

It is an object of the invention to provide a toothed cable not to cause an unnecessary load on a motor or the like, not to cause tear in the cover layer and to have excellent durability.

The toothed cable of the present invention comprises a core cable, and a tooth line helically wound on the outer periphery of the core cable. The toothed cable further comprises a cover layer covering the outer surface of the core cable and the tooth line with a resin continuously. This toothed cable has helical convex portions formed by covering the tooth line with the resin and helical concave portions formed by covering intervals in the tooth line with the resin. The cover layer is in contact with the core cable and the tooth line. The thickness of the cover layer in the region of the helical concave portions is larger than the thickness of the cover layer in the region of the helical convex portions.

According to the present invention, noise can be prevented because the toothed cable has a cover layer. Additionally, due to a small difference in height between the bottom portion of the helical concave portion and the crest portion of the helical convex portion of the toothed cable, the gear to be engaged with the toothed cable is not caught on the helical convex portion and thus an unnecessary load is not caused on a motor or the like.

Moreover, by the thickness of the bottom portions of the helical concave portions being larger than a predetermined value, a cutting of the cover layer due to the gear engaging the toothed cable and engaging and biting into the cover layer of the helical concave portions hardly occurs.

Further, by the thickness of the bottom portions of the helical concave portions being within a predetermined range, it is possible to not only prevent the cutting caused by engaging and biting of the gear which engages the toothed cable, but also prevent the generation of the crack on the cover layer caused by a stress when engaging and biting of the gear.

Furthermore, by a flexural modulus of a resin used for the cover layer being a predetermined value or less, a generation of noise due to the engagement with the gear can be further reduced.

Additionally, by using a thermoplastic elastomer as a resin used for the cover layer, it is possible to further reduce a generation of noise when the gear engages the cover layer and reduce a force of pressing onto the toothed cable when the gear engages and bites into the toothed cable, and thereby it is also possible to improve slidability of the toothed cable.

### BRIEF DESCRIPTION OF THE DRAWINGS

FIG. 1 is a partial sectional view explaining a toothed cable of the present invention.

FIG. 2 shows a state where the toothed cable of the present invention and a gear are engaged.

FIG. 3 is a schematic view of a device which measures load of a motor, noise and durability of the toothed cable in Examples and Comparative Example.

FIG. 4 is a partial sectional view explaining a conventional toothed cable.

FIG. 5 is a partial sectional view explaining a conventional toothed cable.

### DETAILED DESCRIPTION

Hereinafter, the toothed cable of the present invention will be explained in detail with reference to the attached drawings.

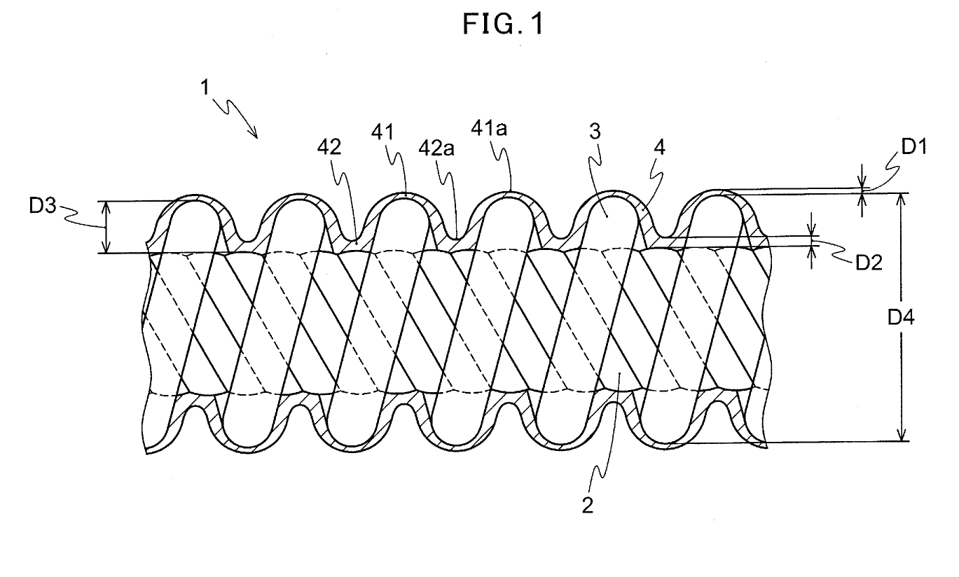

As shown in FIG. 1, the toothed cable 1 of the present invention comprises a core cable 2, a tooth line 3 helically wound on the outer periphery of the core cable 2 and a cover layer 4 which covers the outer surfaces (outer periphery) of the core cable 2 and the tooth line 3 continuously with a resin.

A material equivalent to the one conventionally used for a toothed cable can be used for the core cable 1 and the structure thereof is not limited specifically as long as it has expansion and contraction resistance and torsion resistance. For example, the core cable 1 can be formed by forming a reinforcing layer by winding several metal wires helically on a core wire composed of one metal wire. Furthermore another reinforcing layer is formed by winding several metal wires helically around the wound wires.

The tooth line 3 is formed by helically winding metal wires on the outer periphery of the core cable 2 at even intervals. Though the outer diameters of the core cable 2 and the tooth line 3 are not limited specifically, for example, the outer diameter of the core cable 2 can be within a range of 1 to 4 mm, the outer diameter of the tooth line 3 can be within a range of 0.5 to 2 mm and the outer diameter D4 of the crest portion of the tooth line 3 (a distance between the crest portion of the tooth line 3 in one position and the hypothetical crest portion of the tooth line 3 positioned axisymmetrically with respect to the axis of the toothed cable 1) can be 3 to 7 mm.

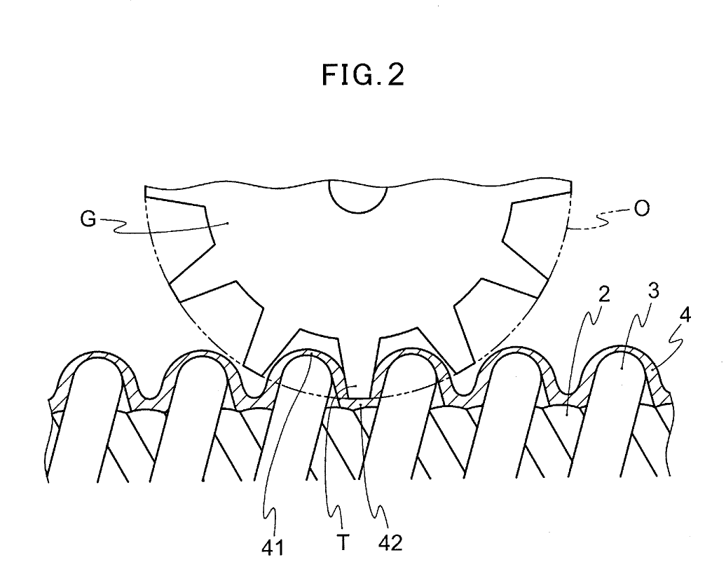

A cover layer 4 used in the present invention will be explained below. As shown in FIG. 1, the cover layer 4 is formed by covering the outer periphery of the core cable 2 and the tooth line 3 with a resin continuously in an axial direction and a circumferential direction of the toothed cable 1. The cover layer 4 of the toothed cable 1 has helical convex portions 41 formed by covering the tooth line 3 with the resin and helical concave portions 42 formed by covering the outer periphery of the core cable 2 between the tooth line 3 with the resin. The helical convex portions 41 prevent noise generated when a gear G (see FIG. 2) engages the toothed cable 1 and the outer periphery of the tooth line 3 contacts the gear G. The helical concave portions 42 protect a portion where the tooth T (see FIG. 2) of the gear G engages and bites into the toothed cable 1. As shown in FIG. 1, the cover layer 4 is provided in contact with the core cable 2 and the tooth line 3, without any clearance space therebetween from the outer periphery of the cover layer 4 to the outer periphery of the core cable 2 and the tooth line 3.

As shown in FIG. 2, the cover layer 4 is pressed by the tooth T of the gear G engaging the helical concave portion 42 of the toothed cable 1. The toothed cable 1 is a member for transmitting a driving force of the gear G and the same portion of the toothed cable 1 is repeatedly pressed by the tooth T of the gear G. However, since the cover layer 4 is provided in contact with the core cable 2 and the tooth line 3, the cover layer 4 is not torn and therefore the toothed cable 1 with excellent durability can be provided. Further, since the cover layer 4 is provided in contact with the core cable 2 and the tooth line 3, it is possible to prevent noise generated when the gear G engages the toothed cable 1 and a higher soundproof effect can be achieved, compared with the one in which clearance spaces are provided between the outer periphery of the core cable 2 and the cover layer 4.

As shown in FIG. 1, the cover layer 4 is formed such that the thickness D2 in the region of the helical concave portions 42 is larger than the thickness D1 in the region of helical convex portions 41. In this manner, clue to the thickness D2 of the cover layer 4 in the region of helical concave portions 42 being larger than the thickness D1 of the cover layer 4 in the region of helical convex portions 41, a difference of height from the bottom portions 42a of the helical concave portions 42 to the crest portions 41a of the helical convex portions 41 becomes smaller. Therefore the gear G to be engaged with the toothed cable 1 is not caught on the helical convex portion 41 and there is no unnecessary load on a driving source such as a motor that drives the gear G. That is, by making the thickness D2 in the region of the helical concave portions 42 larger than the thickness D1 in the region of the helical convex portions 41, in the vicinity of the portion where the tooth T of the gear G engages the toothed cable 1, as shown in FIG. 2, the height of the cover layer 4, which may be an obstacle against an orbit O of the tip of the tooth T of the gear G shown by a two-dot chain line in FIG. 2, becomes lower and a contact length between the tooth T of the gear G and the cover layer 4 becomes shorter. Therefore a contact time between the tooth T of the gear G and the cover layer 4 becomes shorter and unnecessary load on a driving source such as a motor is not caused.

If the thickness D1 in the region of the helical convex portions 41 is large, the crest portions 41a of the helical convex portions 41 intrude into the orbit O of the tip of the tooth T of the gear G and the cover layer 4 may be scraped off by the tip portion of the tooth T of the gear G. However, in the present invention, since the thickness D1 in the region of the helical convex portions 41 is small, the crest portions 41a of the helical convex portions 41 hardly overlap the orbit O. Therefore in the vicinity of the portion where the tooth T of the gear G engages the helical concave portion 42, it is possible to not only reduce the load on the motor, etc. due to the tooth T of the gear G being caught on the crest portion 41a of the helical convex portion 41, but also prevent a damage due to scraping off of the cover layer 4 or the like. Except the engaging portion with the gear G of the toothed cable 1, the toothed cable 1 may be inserted into an outer casing (not shown). In that case, if the cover layer 4 is scraped off and a broken piece of the scraped cover layer 4 remains in the outer casing, slidability of the toothed cable 1 will be decreased. Since a damage of the toothed cable 1 due to scraping off of the cover layer 4 or the like can be prevented, it is possible to prevent a decrease of slidability of the toothed cable 1 sliding in the outer casing.

In order to make it hard for the cover layer 4 to be cut (such as a generation of a crack or a damage) when the gear G engages and bites into the bottom portion 42a of the helical concave portion 42 and to prevent the gear G engaging the toothed cable 1 from being caught on the toothed cable 1, it is preferable that the thickness D2 in the bottom portions 42a of the helical concave portions 42 is equal to or larger than 1.8 times the thickness D1 on the crest portions 41a in the region of the helical convex portions 41. Due to the thickness D2 that is larger than 1.8 times the thickness D1, the cutting of the cover layer 4 when the gear G engages and bites into the bottom portion 42a of the helical concave portion 42 can be easily restrained. In order to not only prevent the cutting caused by engaging and biting of the gear G, but also prevent the generation of the crack on the cover layer 4 caused by a stress when engaging and biting of the gear G, it is further preferable that the relation between the thickness D2 and the thickness D1 is such that the thickness D2 is 1.8 to 7.4 times the thickness D1. Due to the thickness D2 that is smaller than 7.4 times the thickness D1, the generation of the crack on the cover layer 4 caused by a deep engaging and biting of the tip of the tooth T of the gear G can be easily restrained.

Here, it goes without saying that the above numerical range is in the range of 1.8 to 7.4 times the thickness D1, on condition that the height from the outer periphery of the core cable 2 to the bottom portion 42a of the helical concave portion 42 is lower than the height from the outer periphery of the core cable 2 to the crest portion 41a of the helical convex portion 41. In addition, though the thickness D1 and D2 may change due to an abration or deformation of the cover layer 4 by using the toothed cable 1, the thickness D2 being 1.8 to 7.4 times the thickness D1 mentioned in the present invention means the numeral before the use of the toothed cable 1 (initial state). Additionally, the thickness D1 and the thickness D2 can be changed as necessary according to the outer diameter of the core cable 2 and the outer diameter of the tooth line 3. For example, when the outer diameter of the core cable 2 is 2.7 mm and the outer diameter of the toothed cable 1 is 4.7 mm, the thickness D1 may be 0.15 to 0.4 mm and the thickness D2 may be 0.75 to 1.1 mm. In this case, the thickness D1 is 0.15 to 0.4 time larger and the thickness D2 is 0.75 to 1.1 times larger than the depth D3 of a trough formed between the tooth line 3 and the core cable 2.

As a material for the cover layer 4, it is preferable to adopt a resin having a flexural modulus of 300 MPa or less according to ASTM D790 and for example, synthetic resins having flexibility or elasticity and having a low friction coefficient, such as a polyester resin, a polyurethane resin, a polyolefin resin, a fluorocarbon resin and a silicone resin are preferably adopted. Among them, it is further preferable to use a thermoplastic elastomer as a material for the cover layer 4, in view of a noise generated when the gear G engages the toothed cable 1 or slidability in the outer casing of the toothed cable 1. In this case, a thermoplastic elastomer having a flexural modulus of 30 MPa or less, e.g. 15 to 30 MPa according to ASTM D790 can be used and it can further reduce a generation of noise when the gear G engages the helical concave portion 42. If the flexural modulus thereof is less than 15 MPa, it is impossible to effectively reduce a generation of noise at the helical convex portion 41; on the other hand, if the flexural modulus thereof is more than 30 MPa, it becomes difficult for the tooth T to deeply dent in the helical concave portion 42 when the gear G engages the toothed cable 1 and the tooth T of the gear G engages and bites into the helical concave portion 42 and thus it becomes difficult to provide a driving force to the tooth line 3 inside the cover layer 4.

By making the thickness D2 larger than the thickness D1 and adopting a thermoplastic elastomer as a material for the cover layer 4, it is possible to further prevent the helical concave portions 42 from tearing or damaging, with preventing contact noise between the tooth T of the gear G and the toothed cable 1. In addition, by making the thickness D2 larger than the thickness D1 and adopting a thermoplastic elastomer as a material for the cover layer 4, it is possible that the tooth T of the gear G engages and bites into the helical concave 42 by an elastic deformation of the helical concave portion 42 and provides a driving force to the toothed cable 1. Therefore a contact time between the cover layer 4 and the gear G can be further reduced and an unnecessary load on a motor or the like can be further reduced. Moreover, since a pressure against the toothed cable 1 when the gear G engages and bites into the helical concave portion 42 can be absorbed in the cover layer 4, the toothed cable 1 is hardly pressed onto the inner surface of the outer casing and thereby the slidability of the toothed cable 1 can be improved. Additionally, though a cover layer 4 composed of solid contents of resin components is normally used for the cover layer 4, a foamed resin can be also used.

As the methods for producing the toothed cable 1 of the present invention, known methods can be used and the methods are not limited specifically, as long as the thickness D2 of the cover layer 4 in the region of the helical concave portions 42 is larger than the thickness D1 of the cover layer 4 in the region of the helical convex portions 41. An example of the known methods is covering the outer surface of a toothed cable, which is obtained by a known method for producing a toothed cable and is not covered with a resin, with a resin such as a thermoplastic elastomer by extrusion molding, and controlling a resin temperature and a pulling speed such that the thickness D2 of the cover layer in the region of the helical concave portions 42 is larger than the thickness D1 of the cover layer 4 in the region of the helical convex portions 41 to obtain the toothed cable 1 of the present invention.

The present invention will be explained in detail with reference to Examples and Comparative Example below but not limited thereto.

The core cable 2, the tooth line 3 and the cover layer 4 used in Examples and Comparative Example will be explained below simultaneously.

A steel wire having an outer diameter of 1.2 mm was helically wound on the outer periphery of a core cable 2 composed of steel wires and having an outer diameter of 2.7 mm with intervals of 2.54 mm and a tooth line 3 having an outer diameter of 1.0 mm (outer diameter D4 of the crest of the tooth line 3: 4.7 mm) was formed. A cover layer 4 was formed by covering the outer periphery of the core cable 2 and the tooth to line 3 with a polyester elastomer (Hytrel (trademark) available from DU PONT-TORAY CO., LTD.) having a flexural modulus of 27 MPa according to ASTM D790 by extrusion molding such that the thickness of the helical convex portions 41 and the helical concave portions 42 were as defined at the ratio shown in Table 1, and thereby the resin-coated toothed cables 1 of the Examples 1 to 6 and Comparative Example 1 were prepared.

An examination method of measuring a load on a motor caused by the toothed cable, noise and durability of the toothed cable will be explained below.

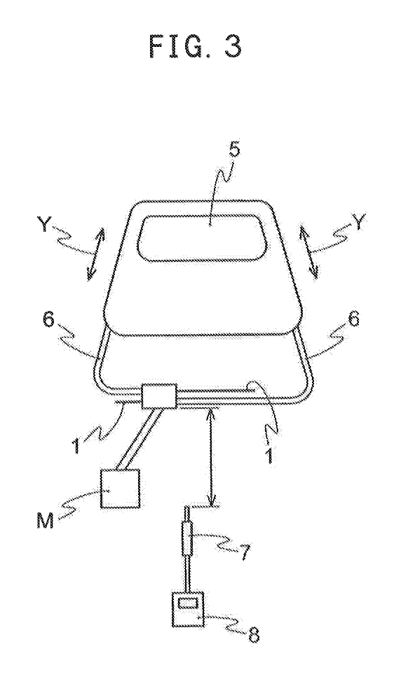

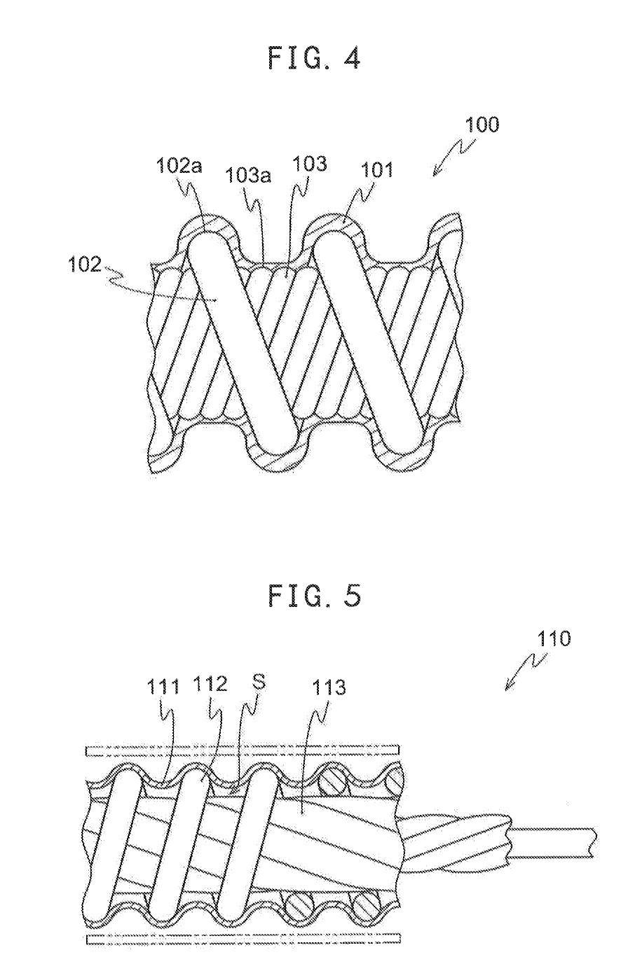

The toothed cables of Examples 1 to 6 and Comparative Example 1 were arranged as shown in FIG. 3. One end of the toothed cable 1 was fixed to a roof lid 5 and at the side of the other end of the toothed cable 1, the toothed cable 1 was engaged with a pinion (not shown) of a motor M. The toothed cable 1 was supported by an outer casing 6 between the installation position of roof lid 5 and the installation position of the motor M. The inner diameter of the outer casing 6 was 6.4 mm. The toothed cable 1 was moved from side to side in FIG. 3 with the motor M and thereby the roof lid 5 moved along an arrow Y. The noise generated was measured with a noise level meter 7 positioned 300 mm directly below the motor M and stored in a data recorder 8. In addition, in order to measure a load on the motor M, an operating current of the motor M at the time was measured.

A durability test was conducted by performing a full stroke operation 10,000 times, where one full stroke operation was performed by operating the toothed cable 1 fixed to the roof lid 5 shown in FIG. 3 with the terminal voltage of 13.5 V of the motor M for a full stroke (from the full open state to the full closed state of the roof lid 5). The state of the cover layer 4 of the toothed cable 1 at the time was evaluated by three-grade is evaluation method. The evaluation criteria of the load, of the motor was determined such that when the operating current was decreased from the initial state, it was evaluated as ◯, when the operating current was increased by less than 25% from the initial state, it was evaluated as Δ and when the operating current was increased by 25% or more from the initial state, it was evaluated as X. With reference to the operating noise, when the sound volume was not changed compared to the initial state, it was evaluated as ◯, when the sound volume was increased by less than 50% from the initial state, it was evaluated as Δ and when the sound volume was increased by 50% or more from the initial state, it was evaluated as X. With reference to the result of durability, in a cutting “cutting” in Table) of the helical concave portion of the cover layer 4 and a crack (“cracking” in Table) of the helical convex portion of the cover layer 4, when no abnormality was observed, it was evaluated as ◯, when a little existence of cuttings or cracks was recognized while they cause no practical problem, it was evaluated as Δ and when cuttings and cracks which can cause a practical problem, it was evaluated as X.

The results of the above test are shown in Table 1.

TABLE 1

| | | Outer | Top | | Bottom | | | | | | |
|---|---|---|---|---|---|---|---|---|---|---|---|
| | | diameter | portion of | | portion of | | | | | | |
| | Outer | of crest | convex portion | | concave portion | | Load | | | | |
| | diameter | of teeth | Outer | Thickness | Outer | Thickness | | Operating | on | Result of durability | |
| | of core | (D4) | diameter | (D1) | diameter | (D2) | D2/D1 | noise | motor | Cutting | Cracking |
| Ex. 1 | 2.7 | 4.7 | 5.6 | 0.45 | 4.1 | 0.7 | 1.5 | ◯ | ◯ | Δ | ◯ |
| Ex. 2 | 2.7 | 4.7 | 5.5 | 0.4 | 4.2 | 0.75 | 1.9 | ◯ | ◯ | ◯ | ◯ |
| Ex. 3 | 2.7 | 4.7 | 5.2 | 0.25 | 4.2 | 0.75 | 3.0 | ◯ | ◯ | ◯ | ◯ |
| Ex. 4 | 2.7 | 4.7 | 5.1 | 0.2 | 4.7 | 1.0 | 5.0 | ◯ | ◯ | ◯ | ◯ |
| Ex. 5 | 2.7 | 4.7 | 5.0 | 0.15 | 4.9 | 1.1 | 7.3 | ◯ | ◯ | ◯ | ◯ |
| Ex. 6 | 2.7 | 4.7 | 4.9 | 0.1 | 4.3 | 0.8 | 8.0 | ◯ | ◯ | ◯ | Δ |
| Com. | 2.7 | 4.7 | 5.1 | 0.2 | 3.1 | 0.2 | 1.0 | X | ◯ | X | ◯ |
| Ex. 1 | | | | | | | | | | | |

Here, Table 1 will be considered. In Comparative Example 1, since the thickness of the helical convex portions and the thickness of the helical concave portions were the same, the load on the motor was satisfactory and was better than the case where the thickness of the helical convex portions was larger than the thickness of the helical concave portions. However, the operating noise thereof was detective and a cutting of the helical concave portion was recognized in the durability test. On the other hand, in Examples 1 to 6, since the thickness of the helical convex portions was smaller than the thickness of the helical concave portions, both the operating noise and the load on the motor thereof were satisfactory. In Examples 2 to 6, since the ratio of the thickness of the helical concave portions to the thickness of the helical convex portions was more than 1.8, a cutting of the helical concave portion was not recognized and both the operating noise and the load on the motor were satisfactory. Moreover, in Examples 2 to 5, since the ratio of the thickness of the helical concave portions to the thickness of the helical convex portions was within a range of 1.8 to 7.4, the results were satisfactory not only in operating noise and load of the motor, but also in a cutting and a cracking.

What is claimed is:

1. A toothed cable comprising a core cable, and a tooth line helically wound on an outer periphery of the core cable,
the toothed cable further comprising a cover layer covering the outer surface of the core cable and the tooth line with a resin continuously,
wherein the toothed cable has helical convex portions formed by covering the tooth line with the resin and helical concave portions formed by covering intervals in the tooth line with the resin, the cover layer is in contact with the core cable and the tooth line and the thickness of the cover layer in the region of the helical concave portions is larger than the thickness of the cover layer in the region of the helical convex portions.

2. The toothed cable according to claim 1, wherein the thickness in the bottom portions of the helical concave portions is equal to or larger than 1.8 times the thickness in the crest portions of the helical convex portions.

3. The toothed cable according to claim 1, wherein the thickness in the bottom portions of the helical concave portions is 1.8 to 7.4 times the thickness in the crest portions of the helical convex portions.

4. The toothed cable according to claim 1, wherein a flexural modulus of the resin is 300 MPa or less.

5. The toothed cable according to claim 2, wherein a flexural modulus of the resin is 300 MPa or less.

6. The toothed cable according to claim 3, wherein a flexural modulus of the resin is 300 MPa or less.

7. The toothed cable according to claim 1, wherein the resin is a thermoplastic elastomer.

8. The toothed cable according to claim 2, wherein the resin is a thermoplastic elastomer.

9. The toothed cable according to claim 3, wherein the resin is a thermoplastic elastomer.
